(19) United States
(12) Patent Application Publication
(10) Pub. No.: US 2012/0266757 A1
(43) Pub. Date: Oct. 25, 2012

(54) AUTOMATIC BREAD MAKER

(76) Inventors: Takashi Watanabe, Tottori-shi (JP); Masayuki Shimozawa, Tottori-shi (JP)

(21) Appl. No.: 13/512,298

(22) PCT Filed: Nov. 18, 2010
(86) PCT No.: PCT/JP2010/070541

§ 371 Date: May 25, 2012

(30) Foreign Application Priority Data
Nov. 27, 2009 (JP) 2009-270384

(51) Int. Cl. A47J 37/01

(52) U.S. Cl. 99/335; 99/353; 99/348

(57) ABSTRACT

An automatic bread maker of the present invention comprises: a container into which bread ingredients are put; a body for receiving the container; and a control unit for executing bread-making steps in a state in which the container has been received in the body. The bread-making steps include a grinding step for grinding cereal grains inside the container, and a post-grinding liquid-absorption step for causing ground flour from cereal grains ground in the grinding step to absorb liquid.

### TECHNICAL FIELD

The present invention relates to an automatic bread maker used mainly in typical households.

### BACKGROUND ART

Automatic bread makers for home use on the market generally have a system to make bread in which a bread container, into which the bread ingredients are put, is used as the baking pan (e.g., refer to Patent Document 1). In such an automatic bread maker, a bread container into which bread ingredients have been put is first introduced into a baking compartment in the body. The bread ingredients in the bread container are subsequently kneaded into a dough using a kneading blade provided in the bread container (kneading step). A fermentation step is then performed to ferment the kneaded dough, and the bread is baked using the bread container as the baking pan (baking step).

Conventionally, flour (wheat flour, rice flour, and the like) produced by milling a cereal such as wheat and rice, or mixed flour produced by mixing various supplementary ingredients into the milled flour, is required when bread is made using such an automatic bread maker.

### LIST OF CITATIONS

### Patent Documents

[Patent Document 1] Japanese Laid-open Patent Application No. 2000-116526

### SUMMARY OF INVENTION

### Technical Problem

In typical households, a cereal grain is sometimes stored in a granular form, as with rice grain, instead of a powdered form. Therefore, it would be convenient if it were possible to make bread directly from cereal grains using an automatic bread maker. In this light, after diligent study the present applicants have invented a method for making bread using cereal grains as a bread ingredient. The present applicants have already submitted a patent application (Japanese Published Unexamined Application No. 2008-201507).

Here, the bread-making method for which an application has already been submitted is introduced. In this bread-making method, cereal grains are first mixed with a liquid, and the mixture is ground by a grinding blade (grinding step). Bread ingredients including the paste-form ground flour obtained from the grinding step are kneaded into a dough (kneading step), the dough is fermented (fermentation step), and the fermented dough is thereafter baked into bread (baking step).

The present applicants found through thoroughgoing research that the temperature of the ground flour obtained immediately after the grinding step became excessively high, and it was undesirable for the flour in such a state to be kneaded into bread dough. The present applicants therefore tried a method in which a cooling apparatus is provided so as to reduce the temperature of the ground flour as rapidly as possible and start the kneading step. However, a problem presented with a configuration in which a cooling apparatus is provided is that the cost of the automatic bread maker is increased.

In view of the above, an object of the present invention is to provide an automatic bread maker that can make good-quality bread from cereal grains, and that is as inexpensive as possible.

### Solution to Problem

In order to achieve the aforementioned object, an automatic bread maker according to the present invention comprises: a container into which bread ingredients are put; a body for receiving the container; and a control unit for executing bread-making steps in a state in which the container has been received in the body, wherein the bread-making procedure includes a grinding step for grinding cereal grains inside the container, and a post-grinding liquid-absorption step for causing ground flour from cereal grains ground in the grinding step to absorb liquid.

In accordance with the present aspect, the bread-making procedure includes a post-grinding liquid-absorption step for causing ground flour from cereal grains to absorb liquid. In the past, investigations have been performed in regard to reducing the temperature at an early stage using a cooling apparatus and starting the kneading step after the grinding of the cereal grains is completed. The present aspect is a converse concept of the foregoing. By providing the post-grinding liquid-absorption step the time until transition to the kneading step is increased in the case that a cooling apparatus is used. However, it was found that by providing a post-grinding liquid-absorption step, not only is a time interval obtained for cooling the ground flour from cereal grains which has increased in temperature, but the ground flour is further broken down and the amount of fine particles increases. It was found that increasing the amount of fine particles enables refined, good-quality (delicious) bread to be baked. In other words, in accordance with the present aspect, good-quality bread can be made from cereal grains, and the cost of the automatic bread maker can be minimized because a cooling apparatus need not be provided.

The automatic bread maker of the aspect described above preferably further comprises: a temperature detector capable of detecting at least one among an outside air temperature, a temperature of the container, a temperature of the surroundings of the container, and a temperature of the bread ingredients inside the container, wherein the control unit controls the time of the post-grinding liquid-absorption step on the basis of the temperature detected by the temperature detector.

In accordance with the present aspect, the time of the post-grinding liquid-absorption step is controlled on the basis of the temperature that affects the cooling speed of the ground flour (the ambient temperature) or the temperature of the ground flour (the temperature obtained directly or indirectly). Therefore, the temperature at the time that the post-grinding liquid-absorption step ends is readily adjusted to a target temperature. In other words, variability in the temperature at the start of the kneading step performed subsequent to the post-grinding liquid-absorption step can be minimized and good-quality bread is readily obtained.

In the automatic bread maker of the aspect described above, the temperature detector may be provided so as to be capable of detecting the temperature of the container; and the control unit may end the post-grinding liquid-absorption step when the temperature of the container has reached a predetermined temperature in the post-grinding liquid-absorption step.

In accordance with the above, a configuration is adopted wherein the temperature of the ground flour is detected (indirectly) and the post-grinding liquid-absorption step is ended at the point at which a predetermined temperature has been reached. Therefore, temperature variability at the start of the subsequently performed kneading step can be effective inhibited. The predetermined temperature is preferably a temperature at which yeast can actively work (e.g., 28° C. to 30° C.).

In the automatic bread maker of the aspect described above, it is preferred that the temperature detector be provided so as to be capable of detecting the outside air temperature in addition to the temperature of the container; and that the control unit end the post-grinding liquid-absorption step when the temperature of the container has reached the outside air temperature in the case that the outside air temperature is higher than a predetermined temperature in the post-grinding liquid-absorption step.

For example, in the case that the ambient temperature is high, as in the summer season, it is possible that the temperature cannot be reduced to a predetermined temperature in a short time. Therefore, it is preferred that the temperature be reduced as much as possible and that the process transition to the subsequent kneading step before the predetermined temperature is reached, as in the present aspect, in order to keep the bread-making time from being needlessly extended. In this case as well, variability in the temperature at the start of the kneading step can be inhibited by a certain amount because of reducing the temperature as much as possible and proceeding to the subsequent kneading step.

In the automatic bread maker of the above-described aspect, it is preferred that the control unit control the post-grinding liquid-absorption step so that the time of the post-grinding liquid-absorption step is a first time or greater and a second time or less; not end the post-grinding liquid-absorption step in the case that the first time has not been reached, even in the case of a determination having been made that the post-grinding liquid-absorption step can be ended on the basis of information from the temperature detector; and end the post-grinding liquid-absorption step in the case that the second time is exceeded, even in the case of a determination having been made that the post-grinding liquid-absorption step cannot be ended on the basis of information from the temperature detector.

As described above, the post-grinding liquid-absorption step is used not only for obtaining a time interval for cooling the ground flour, but also for the effect of increasing the amount of fine particles in the ground flour. It is therefore preferred that the present aspect be employed so that the absorption time does not become excessively short. However, when the first time is set to be excessively long, the ground flour may cool excessively and the temperature at the start of the kneading step may become lower than necessary. It is preferred that the first time be set in consideration of this point. There is the possibility that an extraordinarily long time will be required for the container temperature to decrease to the predetermined temperature or to the outside air temperature. In such a case, the bread-making time may be drastically extended when the start of the kneading step is delayed for a very long time, causing the user to feel inconvenienced. Therefore, the upper limit of the liquid-absorption time is preferably set so that the liquid-absorption time is not excessively extended.

The automatic bread maker of the aspect described above may further comprise: a temperature detector capable of detecting at least any one among an outside air temperature, a temperature of the container, a temperature of the surroundings of the container, and a temperature of the bread ingredients inside the container; wherein the control unit determines an absorption time in the post-grinding liquid-absorption step on the basis of a liquid-absorption time table in which the liquid-absorption time is established in correlation with the temperature, and the temperature detected using the temperature detector prior to the grinding of the cereal grains or after the grinding of the cereal grains.

A liquid-absorption time table (obtained by, e.g., experimentation) correlated with the temperature can be used as in the present aspect, whereby cooling of the ground flour of cereal grains can be sufficiently performed and the variability in the temperature when the post-grinding liquid-absorption step has ended can be inhibited. The liquid-absorption time can be determined on the basis of the temperature detected before or after the grinding of the cereal grains in the case that the temperature detector detects the outside air temperature or the temperature of the surroundings of the container. The liquid-absorption time can be determined on the basis of the temperature detected before the grinding of the cereal grains in the case that the temperature detector detects the container temperature or the temperature of the bread ingredients.

In the automatic bread maker of the above-described aspect, sequentially performed in the bread-making steps may be: a pre-grinding liquid-absorption step for causing liquid to be absorbed by the cereal grains in the container; the grinding step; the post-grinding liquid-absorption step; a kneading step for kneading into bread dough the bread ingredients within the bread container including ground flour from the cereal grains; a fermentation step for fermenting the kneaded bread dough; and a baking step for baking the fermented bread dough.

### Advantageous Effects of the Invention

In accordance with the present invention, it is possible to provide a low-cost automatic bread maker that can make good-quality bread from cereal grains. Therefore, according to the present invention, bread-making at home can be made more accessible.

### BRIEF DESCRIPTION OF THE DRAWINGS

FIG. 1 is a vertical cross-sectional view of an automatic bread maker according to the present embodiment;

FIG. 2 is a partial vertical cross-sectional view of the automatic bread maker according to the present embodiment shown in FIG. 1, cut at right angles with respect to the view shown in FIG. 1;

FIG. 3 is a schematic perspective view for illustrating a configuration of a grinding blade and a kneading blade provided to the automatic bread maker according to the present embodiment;

FIG. 4 is a schematic plan view for illustrating a configuration of a grinding blade and a kneading blade provided to the automatic bread maker according to the present embodiment;

FIG. 5 is a top view of the bread container in the automatic bread maker according to the present embodiment when the kneading blade is in the folded orientation;

FIG. 6 is a top view of the bread container in the automatic bread maker according to the present embodiment when the kneading blade is in the open orientation;

FIG. 7 is a schematic plan view showing the state of the clutch in the automatic bread maker according to the present embodiment when the kneading blade is in the open orientation;

FIG. 8 is a control block diagram of the automatic bread maker according to the present embodiment;

FIG. 9 is an illustrative diagram showing a flow of a rice-grain bread-making procedure of the automatic bread maker according to the present embodiment; and

FIG. 10 is a flow chart showing a detailed flow of a post-grinding water absorption step executed in the automatic bread maker of the present embodiment.

### DESCRIPTION OF EMBODIMENTS

Embodiments of an automatic bread maker according to the present invention will be described in detail below with reference to the accompanying drawings. It is to be understood that any specific time, temperature, or other parameters that appear in this specification are merely examples and are not intended in any way to limit the content of the invention.

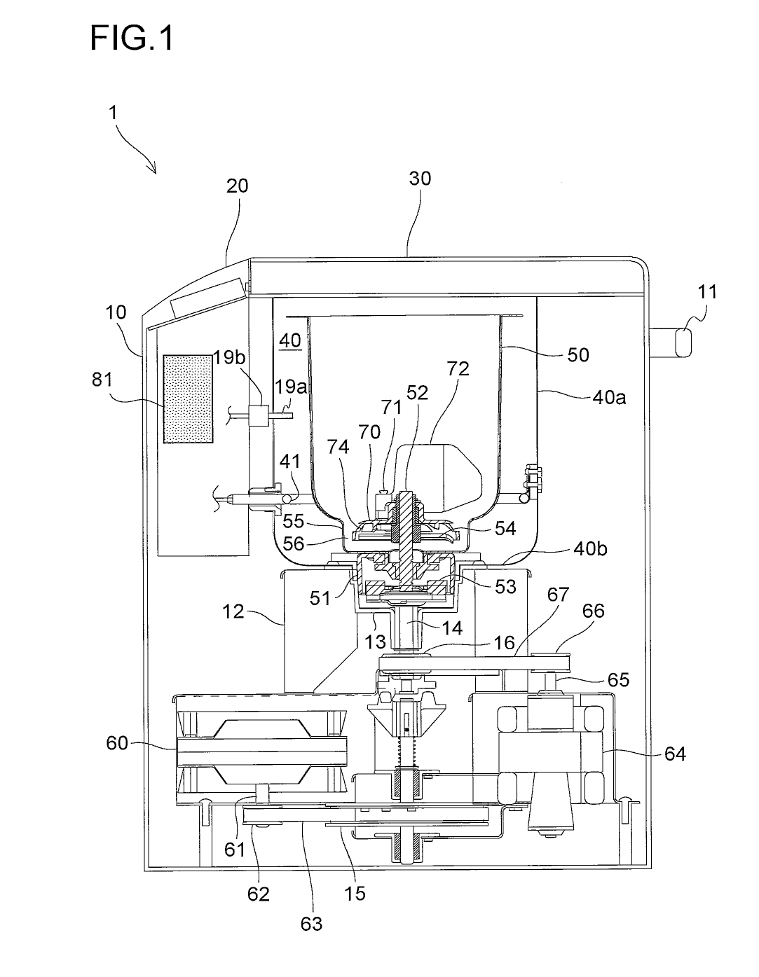

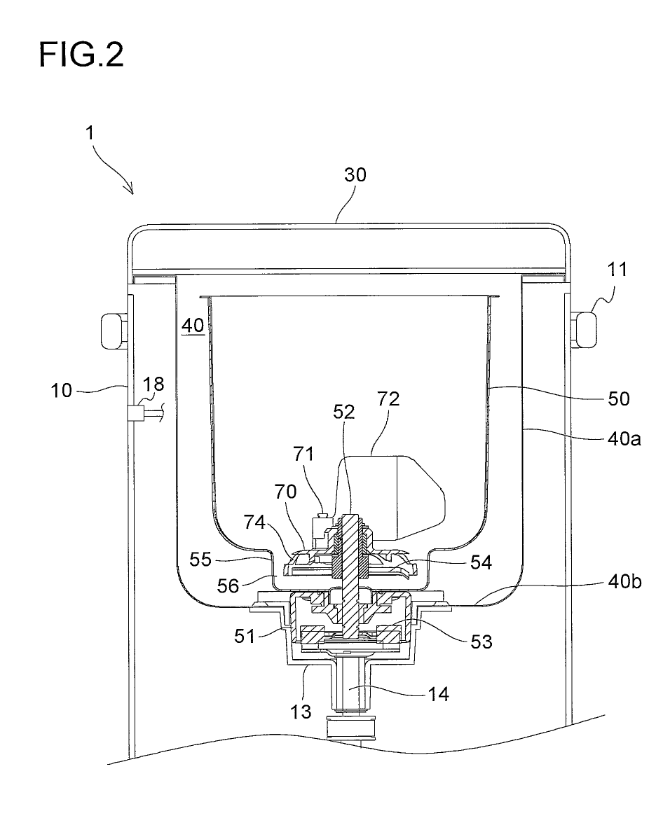

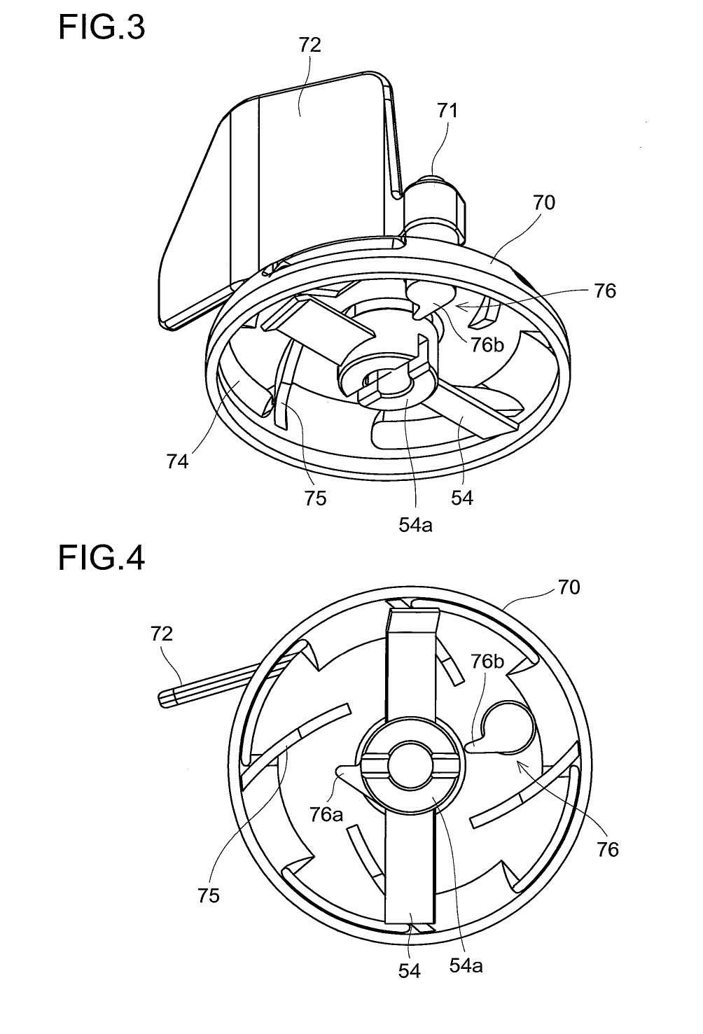

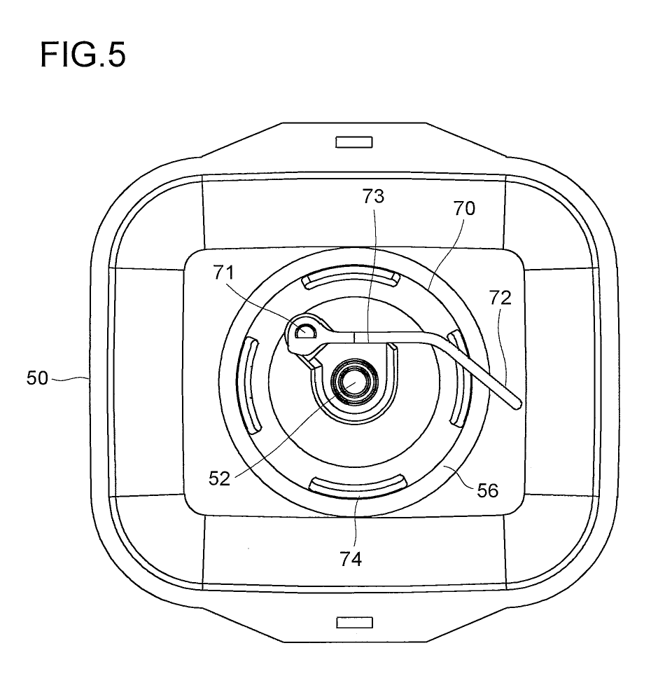

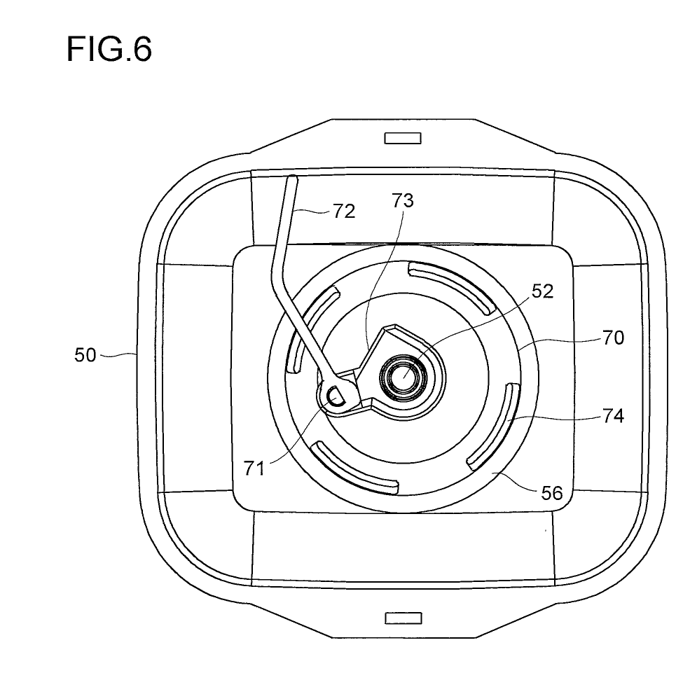

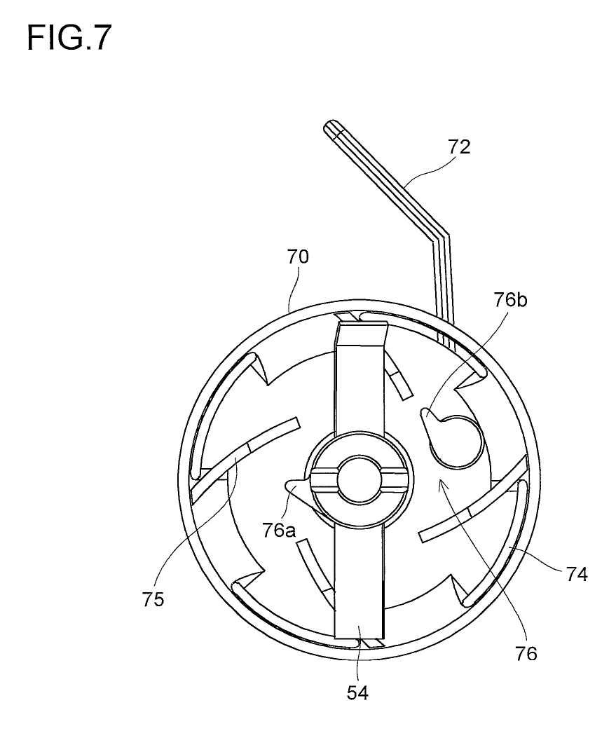

FIG. 1 is a vertical cross-sectional view of an automatic bread maker according to the present embodiment. FIG. 2 is a partial vertical cross-sectional view of the automatic bread maker according to the present embodiment shown in FIG. 1, cut at right angles with respect to the view shown in FIG. 1. FIG. 3 is a schematic perspective view for illustrating a configuration of a grinding blade and a kneading blade provided to the automatic bread maker according to the present embodiment, and is a view observed diagonally from below. FIG. 4 is a schematic plan view for illustrating the configuration of the grinding blade and the kneading blade provided to the automatic bread maker according to the present embodiment, and is a view observed from the bottom. FIG. 5 is a top view of the bread container in the automatic bread maker according to the present embodiment when the kneading blade is in the folded orientation. FIG. 6 is a top view of the bread container in the automatic bread maker according to the present embodiment when the kneading blade is in the open orientation. The overall configuration of the automatic bread maker will be described below with reference to mainly FIGS. 1 through 6. The following conventions are used in the descriptions below.

In FIG. 1, the left side corresponds to the front (front surface), and the right side corresponds to the back (rear surface), of the automatic bread maker 1. Further, for an observer facing the automatic bread maker 1 from directly in front, the observer's left-hand side corresponds to the left side of the automatic bread maker 1, and the observer's right-hand side corresponds to the right side of the automatic bread maker 1.

The automatic bread maker 1 has a box-shaped body 10 made of a plastic shell. The body 10 is provided with plastic U-shaped handles 11 connected to the two ends of the left and right side surfaces of the body 10, whereby the automatic bread maker 1 can be readily transported. An operation part 20 is provided on the front part of the top surface of the body 10. Though not shown in the drawings, the operation part 20 is provided with a group of operation keys such as a start key, a cancel key, a reservation key, a program key, and a selection key for selecting a bread-making procedure (rice-flour-bread procedure, wheat-flour-bread procedure, and the like); and a display unit for displaying the contents of a setup performed by operating the operation keys, errors, and other data. The display unit is configured by a liquid crystal display panel and indicator lamps using light emitting diodes as light sources.

The top surface of the body behind the operation part 20 is covered by a plastic lid 30. The lid 30 is mounted to the back surface of the body 10 by a hinge shaft (not shown), and is configured to swing in a vertical plane about the hinge shaft. The lid 30 is provided with an observation window (not shown) made of heat-resistant glass to allow the user to view a baking compartment 40 (described hereafter) through the observation window.

The baking compartment 40 is provided inside the body 10. The baking compartment 40 is made of a metal plate with the top thereof open, and a bread container 50 is placed into the baking compartment 40 through the opening. The baking compartment 40 comprises a peripheral sidewall 40a, the horizontal cross-section of which is rectangular, and a bottom wall 40b. A sheath heater 41 is disposed inside the baking compartment 40 so as to surround the bread container 50 placed in the baking compartment 40 to enable heating of the bread ingredients in the bread container 50.

A base 12 made of sheet metal is disposed inside the body 10. A bread container support 13 made of a die-cast molding of an aluminum alloy is fixed at a location corresponding to the center of the baking compartment 40 in the base 12. The interior of the bread container support 13 is exposed within the baking compartment 40.

A motor shaft 14 is vertically supported at the center of the bread container support 13. The motor shaft 14 is caused to rotate via pulleys 15 and 16. Clutches are disposed between the pulley 15 and the motor shaft 14, and between the pulley 16 and the motor shaft 14. A system is therefore provided in which the rotation of the motor shaft 14 is not transmitted to the pulley 16 when the pulley 15 is caused to rotate in one direction and the rotation is transmitted to the motor shaft 14, and in which the rotation of the motor shaft 14 is not transmitted to the pulley 15 when the pulley 16 is caused to rotate in a direction opposite to that of the pulley 15 and the rotation is transmitted to the motor shaft 14.

The unit that causes the pulley 15 to rotate is the kneading motor 60 fixed to the base 12. The kneading motor 60 is a vertical shaft, and an output shaft 61 protrudes from the bottom surface thereof. A pulley 62 connected to the pulley 15 by a belt 63 is fixed to an output shaft 61. The kneading motor 60 is a low-speed/high-torque motor, and the pulley 62 causes the pulley 15 to rotate at a reduced speed. Therefore, the motor shaft 14 rotates at a low speed and high torque.

Similarly, a grinding motor 64 supported on the base 12 causes the pulley 16 to rotate. The grinding motor 64 is also a vertical shaft, and an output shaft 65 protrudes from the top surface thereof. A pulley 66 connected to the pulley 16 by a belt 67 is fixed to an output shaft 65. The grinding motor 64 serves to impart high-speed rotation to a grinding blade described hereafter. Therefore, a high-speed motor is selected for the grinding motor 64, and the speed reduction ratio of the pulley 66 and the pulley 16 is set at approximately 1:1.

The bread container 50 is made from sheet metal and has the shape of a bucket, there being a handle for gripping (not shown) mounted on the rim thereof. The horizontal cross-section of the bread container 50 is a rectangle with four rounded corners. A recess 55 is formed in the bottom part of the bread container 50 to accommodate a grinding blade 54 (described in detail hereafter) and a cover 70. The recess 55 is a circular planar shape and is provided with a gap 56 between the external periphery of the cover 70 and the inside surface of the recess 55 to allow the flow of bread ingredients. Further, a cylindrical pedestal 51 made of a die-cast molding of an aluminum alloy is provided to the bottom surface of the bread container 50. The bread container 50 is disposed in the baking compartment 40 with the bread container support 13 accepting the pedestal 51.

A vertically extending blade rotation shaft 52 is supported at the center of the bottom part of the bread container 50 in a state in which sealing is applied. A rotary force is transmitted to the blade rotation shaft 52 from the motor shaft 14 via a coupling 53. Of the two members constituting the coupling 53, one member is fixed to the bottom end of the blade rotation shaft 52 and the other member is fixed to the top end of the motor shaft 14. The entirety of the coupling 53 is enclosed in the pedestal 51 and the bread container support 13.

Projections (not shown) are formed on the internal circumferential surface of the bread container support 13 and the external circumferential surface of the pedestal 51, and these projections constitute a known bayonet coupling. Specifically, when the bread container 50 is to be mounted on the bread container support 13, the projections on the pedestal 51 are kept from interfering with the projections on the bread container support 13, and the bread container 50 is lowered thereon. After the pedestal 51 is fitted into the bread container support 13, the projections of the pedestal 51 engage with the lower surfaces of the projections of the bread container support 13 when the bread container 50 twists horizontally. The bread container 50 is thereby prevented from slipping out upwards. Further, connection with the coupling 53 is simultaneously achieved by this operation.

The twisting direction of the bread container 50 when the bread container 50 is mounted matches the rotation direction of a kneading blade 72 described hereafter, and therefore the bread container 50 is prevented from separating even with the rotation of the kneading blade 72.

The grinding blade 54 is mounted on the blade rotation shaft 52 at a location slightly above the bottom of the bread container 50. The grinding blade 54 is mounted on the blade rotation shaft 52 in a manner so as to be unable to rotate with respect to the blade rotation shaft 52. The grinding blade 54 is made of a stainless steel plate and has a shape such as that of an airplane propeller (this shape is merely an example) as shown in FIGS. 3 and 4. The grinding blade 54 is configured so as to be pulled away and separated from the blade rotation shaft 52, enabling cleaning to be performed after making bread and the grinding blade 54 to be replaced when the edge thereof becomes dull.

A dome-shaped cover 70 having a circular planar shape is mounted on the top end of the blade rotation shaft 52. The cover 70 is made of a die-cast molding of an aluminum alloy. The cover 70 is supported by a hub 54a of the grinding blade 54 and conceals the grinding blade 54. The cover 70 can also be easily pulled away from the blade rotation shaft 52, enabling cleaning to be readily performed after making bread.

The kneading blade 72, which has a “V” shape when viewed from above, is mounted on the top exterior surface of the cover 70 by way of a support shaft 71 that is mounted in a location set at a distance from the blade rotation shaft 52 and that extends in the vertical direction. The kneading blade 72 is made of a die-cast molding of an aluminum alloy. The support shaft 71 is fixed to or integrated with the kneading blade 72 and moves with the kneading blade 72.

The kneading blade 72 swings about the support shaft 71 within the horizontal plane, and has a folded orientation shown in FIG. 5 and an open orientation shown in FIG. 6. In the folding position, the kneading blade 72 contacts a stopper 73 formed on the cover 70, and cannot swing any further in the clockwise direction relative to the cover 70. At this time, the tip of the kneading blade 72 protrudes slightly from the cover 70. In the open orientation, the tip of the kneading blade 72 is separated from the stopper 73 and protrudes significantly from the cover 70.

Windows 74 linking the inner space of the cover to the outer space thereof, and ribs 75 provided to the inner surface of the cover 70 and corresponding to the respective windows 74 are formed in the cover 70. The ribs 75 are used for guiding the ingredients ground by the grinding blade 54 toward the windows 74. This configuration improves the efficiency of the grinding in which the grinding blade 54 is used.

As shown in FIG. 4, a clutch 76 is interposed between the cover 70 and the blade rotation shaft 52. The clutch 76 connects the blade rotation shaft 52 and the cover 70 in the rotation direction of the blade rotation shaft 52 when the kneading motor 60 causes the motor shaft 14 to rotate (this rotation direction is the “forward direction”). Conversely, the clutch 76 disconnects the blade rotation shaft 52 from the cover 70 in the rotation direction of the blade rotation shaft 52 when the grinding motor 64 causes the motor shaft 14 to rotate (this rotation direction is the “reverse direction”). In FIGS. 5 and 6, the “forward direction rotation” is the counter-clockwise direction rotation and the “reverse direction rotation” is the clockwise direction rotation.

The clutch 76 switches the connection states according to the position of the kneading blade 72. In other words, when the kneading blade 72 is in the closed orientation shown in FIG. 5, the second engaging body 76b interferes with the rotation path of the first engaging body 76a, as shown in FIG. 4. Therefore, the first engaging body 76a and the second engaging body 76b engage when the blade rotation shaft 52 rotates in the forward direction, and the rotary force of the blade rotation shaft 52 is transmitted to the cover 70 and the kneading blade 72. In contrast, when the kneading blade 72 is in the open orientation as shown in FIG. 6, the second engaging body 76b departs from the rotation path of the first engaging body 76a, as shown in FIG. 7. Therefore, even when the blade rotation shaft 52 rotates in the reverse direction, the first engaging body 76a and the second engaging body 76b do not engage with each other. The rotary force of the blade rotation shaft 52 accordingly is not transmitted to the cover 70 and the kneading blade 72. FIG. 7 is a schematic plan view showing the state of the clutch when the kneading blade is in the open orientation.

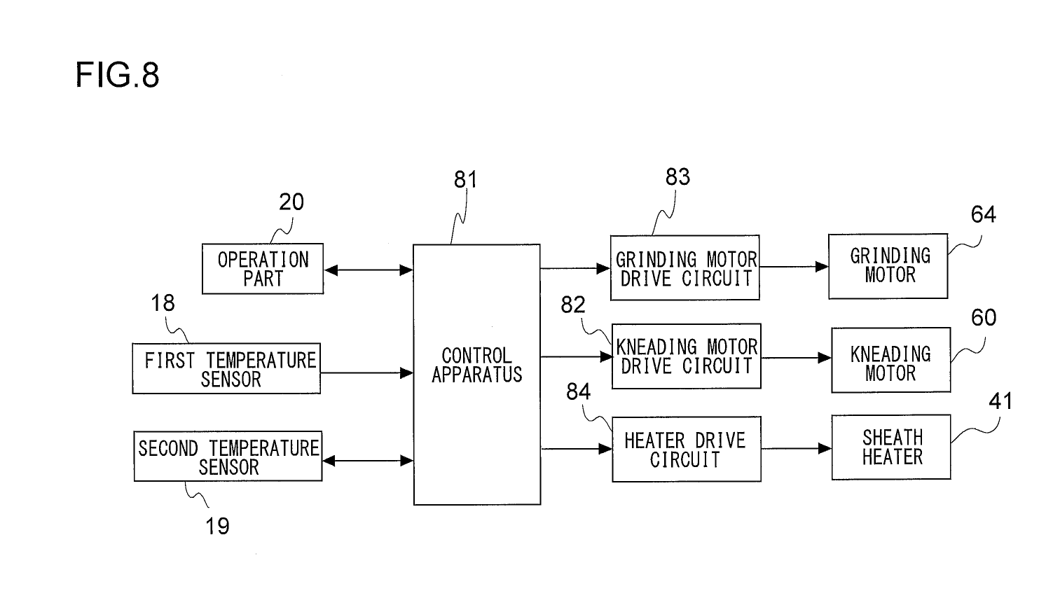

FIG. 8 is a block diagram showing a control of the automatic bread maker according to the present embodiment. A control apparatus 81 controls the operation of the automatic bread maker 1, as shown in FIG. 8. The control apparatus 81 is configured using, for example, a microcomputer composed of a central processing unit (CPU), read only memory (ROM), random access memory (RAM), input/output (I/O) circuitry, and other components. The control apparatus 81 is preferably disposed in a position where heat from the baking compartment 40 will not tend to affect the control apparatus. The control apparatus 81 is disposed between the front sidewall of the body 10 and the baking compartment 40 in the automatic bread maker 1.

A first temperature detector 18, a second temperature detector 19, the operation part 20 described above, a kneading motor drive circuit 82, a grinding motor drive circuit 83, and a heater drive circuit 84 are electrically connected to the control apparatus 81.

As shown in FIG. 2, the first temperature detector 18 is a temperature sensor capable of detecting an outside air temperature and is provided to the side surface of the body 10. As shown in FIG. 1, the second temperature detector 19 comprises a temperature sensor 19a and a solenoid 19b, and is provided so that the distal end side of the temperature sensor 19a protrudes from the front sidewall of the baking compartment 40 into the baking compartment 40. The solenoid 19b allows the tip of the temperature sensor 19a to switch between a position in contact with the bread container 50 and a position not in contact therewith. FIG. 1 shows a case in which the tip of the temperature sensor 19a is in the position not in contact with the bread container 50. By switching the distal end position of the temperature sensor 19a, it is possible to switch the second temperature detector 19 between detecting the temperature inside the baking compartment 40 and the temperature of the bread container 50.

The kneading motor drive circuit 82 is a circuit for controlling the drive of the kneading motor 60 under instruction from the control apparatus 81. The grinding motor drive circuit 83 is a circuit for controlling the drive of the grinding motor 64 under instruction from the control apparatus 81. The heater drive circuit 84 is a circuit for controlling the operation of the sheath heater 41 under instruction from the control apparatus 81.

The control apparatus 81 reads a program stored in ROM or the like and related to a procedure for making bread (a bread-making procedure) on the basis of an input signal from the operation part 20, and causes the automatic bread maker 1 to carry out a bread-making step while controlling the rotation of the kneading blade 72 via the kneading motor drive circuit 82; the rotation of the grinding blade 54 via the grinding motor drive circuit 83; and the heating operation by the sheath heater 41 via the heater drive circuit 84. Further, the control apparatus 81 comprises a time measurement function, making it possible to perform time control in the bread-making step.

The control apparatus 81 is an embodiment of the control unit according to the present invention. The first temperature detector 18 and second temperature detector 19 are an embodiment of the temperature detector according to the present invention. The kneading blade 72, kneading motor 60, and kneading motor drive circuit 82 are an example of kneading means (a kneading unit). The grinding blade 54, grinding motor 64, and grinding motor drive circuit 83 are an example of grinding means (a grinding unit). The sheath heater 41 and heater drive circuit 84 are an example of heating means (a heating unit).

The automatic bread maker 1 of the present embodiment configured as described above is enabled to execute a bread-making procedure (a rice-grain bread-making procedure), in which bread is made from rice grains (a form of cereal grains), in addition to a bread-making procedure in which bread is made from wheat flour or rice flour. The automatic bread maker 1 features a control operation for the case in which the rice-grain bread-making procedure for making bread from rice grains is executed. Therefore, only the control operation of the case in which bread is made from rice grains using the automatic bread maker 1 will be described below.

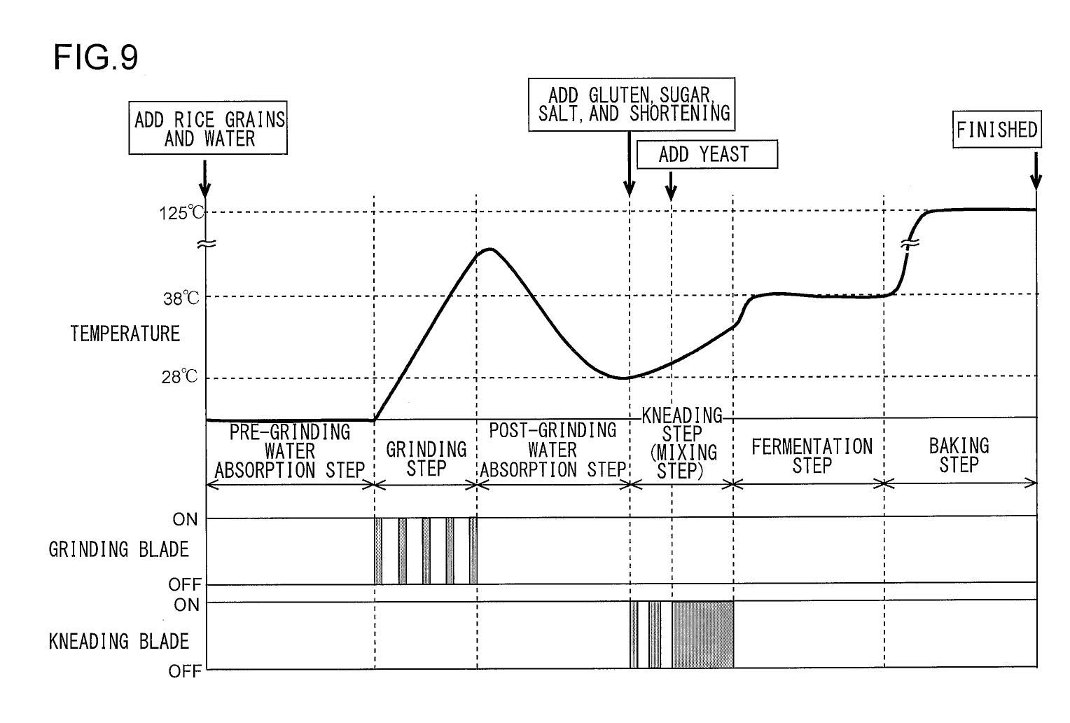

FIG. 9 is an illustrative diagram showing a flow of a rice-grain bread-making procedure in the automatic bread maker of the present embodiment. The temperature indicates that of the bread container 50 in FIG. 9. In the rice grain bread-making procedure, the following steps are sequentially performed in the following order: a pre-grinding water absorption step (one aspect of a pre-grinding liquid-absorption step), a grinding step, a post-grinding water absorption step (one aspect of a post-grinding liquid-absorption step), a kneading (mixing) step, a fermentation step, and a baking step as shown in FIG. 9.

A user mounts the grinding blade 54 and the cover 70, on which the kneading blade 72 is attached, in the bread container 50 in order to perform the rice-grain bread-making procedure. The user then measures the respective predetermined amounts of rice grains and water (e.g., 220 grams of rice grains and 210 grams of water) and places them in the bread container 50. Here, rice grains and water are mixed, but a liquid having a taste component such as a soup stock, fruit juice, a liquid containing alcohol, or another liquid, for example, may be used in place of plain water. The user inserts the bread container 50, into which the rice grains and water have been put, into the baking compartment 40, closes the lid 30, selects a rice grain bread-making procedure by operating the operation part 20, and presses the start button. This starts the rice-grain bread-making procedure for making bread from the rice grains.

The pre-grinding water absorption step aims to facilitate the subsequent grinding of rice grains to the core by causing the rice grains to absorb water (one aspect of liquid). In the pre-grinding water absorption step, the control apparatus 81 performs a control so that the mixture of rice grains and water is left standing for a predetermined time (e.g., 50 minutes) inside the bread container 50. The predetermined time can be obtained by experimentation as a time over which the later grinding step can be performed at high efficiency.

Since the water-absorption speed of rice varies depending on the water temperature, it is possible to use a configuration in which, e.g., the temperature of the bread container 50 is detected by the second temperature detector 19 (temperature detection in a state in which the distal end of the temperature sensor 19a is in contact with the container 50), and the time of the pre-grinding water absorption step is changed depending on the detection temperature. Specifically, e.g., the relationship between the temperature of the bread container 50 and the optimal water-absorption time is investigated by experimentation in advance (e.g., the water-absorption time is investigated at 5° C. intervals between 5° C. and 35° C.), and this information is recorded in the ROM of the control apparatus 81. The temperature of the bread container 50 is detected at a stage in which the rice grains and water have been placed in the bread container 50 and are at rest, and the water-absorption time is determined from the detected temperature and the information stored in the control apparatus 81 in advance. The pre-grinding water absorption step can be executed in the water-absorption time thus determined.

The grinding blade 54 may be caused to rotate in the initial stage of the pre-grinding water absorption step, and the grinding blade 54 may be caused to rotate intermittently thereafter. Such a configuration makes it possible to scar the surfaces of the rice grains, improving the liquid-absorption efficiency of the rice grains.

When the pre-grinding water absorption step is ended, the grinding step for grinding the rice grains is executed according to an instruction from the control apparatus 81. In the grinding step, the grinding blade 54 is rotated at high speed in the mixture of rice grains and water. Specifically, the control apparatus 81 controls the grinding motor 64, rotating the blade rotation shaft 52 in the reverse direction and starting the grinding blade 54 rotating in the mixture of rice grains and water. In this event, the cover 70 also starts to rotate in association with the rotation of the blade rotation shaft 52, but the following operation immediately stops the rotation of the cover 70.

The rotation direction of the cover in accompaniment with the rotation of the blade rotation shaft 52 for rotating the grinding blade 54 is clockwise in FIG. 5, and, in a case where the kneading blade 72 has been in the folded orientation (the orientation shown in FIG. 5), the kneading blade is changed to the open orientation (the orientation shown in FIG. 6) by resistance from the mixture of the rice grains and water. When the kneading blade 72 moves to the open orientation, the second engaging body 76b departs from the rotation path of the first engaging body 76a, and therefore the clutch 76 disconnects the blade rotation shaft 52 from the cover 70 as shown in FIG. 7. At the same time, the kneading blade 72 in the open orientation hits the inner wall of the bread container 50 as shown in FIG. 6, stopping the rotation of the cover 70.

In the grinding step, the grinding of the rice grains is executed in a state in which water has been absorbed in the rice grains by the preceding pre-grinding water absorption step, and therefore the rice grains are readily ground to their cores. The grinding blade 54 rotates intermittently. The intermittent rotation is executed for five cycles in which, e.g., rotation is performed for one minute and rotation is stopped for three minutes. In the final cycle, the three minute stoppage is not performed. The rotation of the grinding blade 54 may be continuous rotation, but intermittent rotation is preferred because the intermittent rotation makes it possible to grind the rice grains evenly by causing the grains to circulate.

The grinding step is ended in a predetermined length of time in the automatic bread maker 1 (17 minutes in the present embodiment). However, the hardness of the rice grains may vary, and the granularity of the ground flour may vary depending on ambient conditions. It is therefore possible to use a configuration in which the end of the grinding step is determined using the magnitude of the load (torque) during grinding as an indicator.

Further, the temperature sensor 19a of the second temperature detector 19 is preferably positioned so as not to contact the bread container 50, because the bread container 50 vibrates significantly during the grinding step. It is thus possible to prevent damage to the temperature sensor 19a and the bread container 50.

As shown in FIG. 9, the temperature of the bread container 50 (the temperature of the ground flour within the bread container 50) rises due to friction during grinding in the grinding step. The temperature of the bread container 50 reaches, for example, about 40 to 45° C. If dough is made by feeding yeast in such a state, the yeast will not work and high-quality bread cannot be made. The automatic bread maker 1 is therefore provided with a post-grinding water absorption step in which the ground flour of rice grains is left immersed in water after the grinding step.

The post-grinding water absorption step is a cooling period for lowering the temperature of the ground flour of rice grains and, at the same time, is also a step functioning to increase the amount of fine particles by causing the ground flour to further absorb water. Thus increasing the fine particles makes it possible to bake bread with a fine texture. A configuration is possible in which the post-grinding water absorption step is performed just for a predetermined time. In the case of such a configuration, however, inconsistencies in the temperature of the bread container 50 (the bread ingredients) at the start of the subsequently performed kneading step may be generated by, for example, the effects of the ambient temperature and the like, sometimes leading to a failure to make high quality bread.

As one countermeasure, a configuration is possible in which the ambient temperature is detected when the grinding step is ended (or possibly before the grinding step is started) by using the first temperature detector 18 (for detecting the outside air temperature) or the second temperature detector 19 (the distal end of the temperature sensor 19a is set in a state of not being allowed to contact the bread container 50; specifically, the detector is used in a mode for detecting the temperature of the surroundings of the bread container 50 (the temperature inside of the baking compartment 40)), and the time for the post-grinding water absorption step is determined on the basis of the ambient temperature. It is thereby possible to minimize the inconsistencies in the temperature of the bread container 50 when the post-grinding water absorption step is ended.

Specifically, e.g., an investigation is performed by experimentation in advance on the relationship between the ambient temperature and the time for the temperature of the bread container 50 to reach the optimal temperature (e.g., about 28° C. to 30° C.) after the grinding step. The information is stored in the ROM of the control apparatus 81. The optimal water-absorption time in 5° C. intervals for the ambient temperature in an ambient temperature range of, e.g., 5° C. to 35° C. is investigated and stored. The ambient temperature is detected as described above, the water-absorption time is determined from the detected temperature and the information stored in advance in the control apparatus 81, and a post-grinding water absorption step can be executed for the time thus determined.

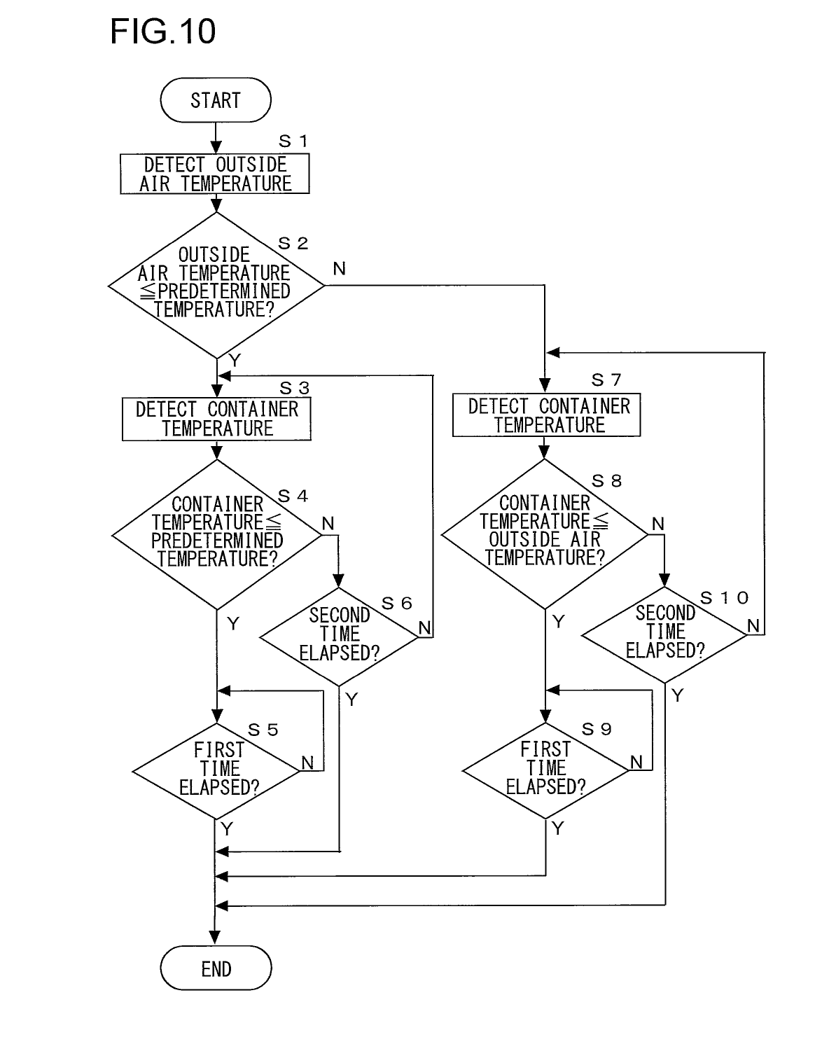

In the automatic bread maker 1 of the present embodiment, the post-grinding water absorption step is executed with a different flow such as that shown in FIG. 10 rather than the flow described above.

Upon the conclusion of the grinding step, the control apparatus 81 detects the outside air temperature using the first temperature detector 18 (step S1). The control apparatus 81 confirms whether or not the detected outside air temperature is at or below a predetermined temperature (step S2) that has been preset. The predetermined temperature is the preferable temperature when the kneading step starts, and is set at, for example, from 28° C. to 30° C.

In the case that the outside air temperature is no higher than the predetermined temperature (Yes in step S2), the control apparatus 81 detects the temperature of the bread container 50 using the second temperature detector 19 (step S3). Here, the temperature is detected with the tip of the temperature sensor 19a of the second temperature detector 19 contacting the bread container 50. The control apparatus 81 then confirms whether or not the detected temperature of the bread container 50 is no higher than the predetermined temperature (step S4).

If the detected temperature of the bread container 50 is no higher than the predetermined temperature (Yes in step S4), the control apparatus 81 confirms whether or not a preset first time (e.g., 30 minutes) has elapsed since starting the post-grinding water absorption step (step S5). The first time is provided so as to prevent the time for the post-grinding water absorption step from being excessively shortened. That is, the post-grinding water absorption step also functions to increase the amount of fine particles of the ground flour by causing the ground flour obtained by the grinding step to further absorb water as described above. Therefore, the first time is set to prevent the post-grinding water absorption step from being undesirably shortened. When the first time is set to an excessive length, the ground flour will be excessively cooled, causing inconsistencies in the temperature when the kneading step starts. Therefore, the first time is preferably set to prevent occurrences of the aforementioned problems. In an alternative configuration, step S5 for confirming whether or not the first time has elapsed is not provided.

If the first time has elapsed from the start of the post-grinding water absorption step (Yes in step S5), the control apparatus 81 ends the post-grinding water absorption step. In contrast, if the first time has not elapsed from the start of the post-grinding water absorption step (No in step S5), the control apparatus 81 waits for the first time to elapse and ends the post-grinding water absorption step.

If the detected temperature of the bread container 50 is higher than the predetermined temperature (No in step S4), the control apparatus 81 confirms whether or not a preset second time (longer than the first time; e.g., 60 minutes) has elapsed since the start of the post-grinding water absorption step (step S6). If the second time has elapsed (Yes in step S6), the control apparatus 81 ends the post-grinding water absorption step even if the temperature of the bread container 50 has not reached the predetermined temperature. In contrast, if the second time has not elapsed (No in step S6), the sequence is returned to step S3 to perform the operations of step S3 and subsequent steps.

Step S6 for confirming whether or not the second time has elapsed from the start of the post-grinding water absorption step is provided for the following reasons. There is the possibility that a considerable time will be required for the temperature of the bread container 50 to decrease to the predetermined temperature. In such a case, the bread-making time may be drastically extended when the start of the kneading step is delayed for a very long time, causing the user to feel inconvenienced. Therefore, the second time is set as the upper limit of the water absorption time so as to prevent the time for the post-grinding water absorption step from being excessively extended. In an alternative configuration, step S6 is not provided. In such a case, the post-grinding water absorption step is ended after the temperature of the bread container 50 reaches to the predetermined temperature.

When the outside air temperature is higher than the predetermined temperature, it is impossible to decrease the temperature of the bread container 50 to the predetermined temperature in the post-grinding water absorption step. Therefore, as a general rule, the post-grinding water absorption step is ended in this case when the temperature of the bread container 50 decreases to the outside air temperature. The sequence is described in detail below.

That is, in step S2, if the outside air temperature is higher than the predetermined temperature (No in step S2), the control apparatus 81 detects the temperature of the bread container 50 using the second temperature detector 19 (step S7). The control apparatus 81 confirms whether or not the detected temperature of the bread container 50 is no higher than the outside air temperature (step S8).

If the detected temperature of the bread container 50 is no higher than the outside air temperature (Yes in step S8), the control apparatus 81 confirms whether or not the first time has elapsed from the start of the post-grinding water absorption step (step S9). The first time is determined in a manner similar to the case in step S5. As with step S5, a configuration is possible in which step S9 is not provided.

If the first time has elapsed from the start of the post-grinding water absorption step (Yes in step S9), the control apparatus 81 ends the post-grinding water absorption step. In contrast, if the first time has not elapsed from the start of the post-grinding water absorption step (No in step S9), the control apparatus 81 waits for the first time to elapse and ends the post-grinding water absorption step.

If the detected temperature of the bread container 50 is higher than the outside air temperature (No in step S8), the control apparatus 81 confirms whether or not a preset second time has elapsed from the start of the post-grinding water absorption step (step S10). If the second time has elapsed (Yes in step S10), the post-grinding water absorption step is ended even if the temperature of the bread container 50 has not reached the outside air temperature. In contrast, if the second time has not elapsed (No in step S10), the sequence is returned to step S7 to perform the operations of step S7 and subsequent steps.

Step S10 is provided for the same reasons step S6 is provided. As with step S6, in an alternative configuration step S10 is not provided. In such a case, a post-grinding water absorption step is ended when the temperature of the bread container 50 decreases to the outside air temperature.

Upon completion of the post-grinding water absorption step, a kneading step is subsequently performed. At the start of the kneading step, gluten, and seasonings such as salt, sugar, and shortening are fed into the bread container 50 by the respective amounts (e.g., 50 grams of gluten, 16 grams of sugar, 4 grams of salt, and 10 grams of shortening). These seasonings may be fed, for example, manually by the user, or automatically by providing an automatic feeder that will free the user from this task.

Gluten is not an essential bread ingredient. Gluten can therefore be added to the bread ingredients as deemed necessary by the user. A thickening stabilizer (e.g., guar gum) may be added in place of gluten.

When the kneading step for kneading the bread ingredients, which contains the ground flour of rice grains ground in the grinding step, into dough is started inside the bread container 50, the control apparatus 81 controls the kneading motor 60 and causes the blade rotation shaft 52 to rotate in the forward direction. The cover 70 rotates in the forward direction (i.e., CCW in the view of FIG. 6) in association with the rotation in the forward direction of the blade rotation shaft 52, causing the kneading blade 72 to change from the open position (refer to FIG. 6) to the folding position (refer to FIG. 5) due to the drag of the bread ingredients contained in the bread container 50. As a result, the clutch 76 forms an angle that causes the second engaging body 76b to interfere with the rotation path of the first engaging body 76a, thus connecting the blade rotation shaft 52 to the cover 70 as shown in FIG. 4. This causes the cover 70 and kneading blade 72 to integrally rotate in the forward direction with the blade rotation shaft 52. The kneading blade 72 rotates at a slow speed and high torque.

The bread ingredients are mixed and kneaded by the rotation of the kneading blade 72 to become an integrated ball of dough having a prescribed elasticity. The kneading blade 72 tosses the dough about and beats it against the inner wall of the bread container 50, adding the element of “working” to the kneading. The rotation of the kneading blade 72 in the kneading step may be continuous from beginning to end, but in the automatic bread maker 1, the kneading blade 72 rotates intermittently in the initial stage of the kneading step and continuously in the latter half of the kneading step.

In the automatic bread maker 1, yeast (e.g., dry yeast) is fed at the stage where the intermittent rotation performed initially has ended. The yeast may be fed manually by the user, or may be automatically fed. The reason for not feeding the yeast together with the gluten or the like is to prevent the yeast (dry yeast) from coming into direct contact with water as much as possible. Depending on the situation, the yeast, gluten and the like may be fed together.

In the automatic bread maker 1, the time for the kneading step is a predetermined time (e.g., 15 minutes) determined by experimentation as the time required to obtain a bread dough having the desired elasticity. However, when the time for the kneading step is fixed, the quality of the bread dough may vary due to the ambient temperature. It is therefore possible to use a configuration in which the outside air temperature (depending on the case, the temperature inside the baking compartment 40) is detected at the start of the kneading step, and the time required for the kneading step is modified depending on the outside air temperature. It is preferred that the kneading step be shortened in the case that the ambient temperature is high, and that the kneading step be lengthened in the case that the ambient temperature is low. It is also possible to use a configuration in which the timing at which the kneading step is ended is determined using the magnitude of the load (torque) during kneading as an indicator, in order to prevent variation in the quality of the bread dough.

In the automatic bread maker 1, the control apparatus 81 controls the sheath heater 41 so as to adjust the temperature of the baking compartment 40 to a predetermined temperature (e.g., 32 C or the like). In this case, the tip of the temperature sensor 19a of the second temperature detector 19 is positioned so as not to come in contact with the bread container 50. Therefore, the temperature sensor 19a and bread container 50 do not tend to become damaged during the kneading step in which the bread container 50 vibrates greatly. When bread containing additional ingredients (e.g., raisins) is baked, the additional ingredients are to be fed during the kneading step.

When the kneading step is ended, a fermentation step is carried out according to an instruction from the control apparatus 81. In the fermentation step, the control apparatus 81 controls the sheath heater 41 and sets the temperature of the baking compartment 40 to a temperature (e.g., 38° C.) that promotes fermentation. The dough is left standing for a predetermined time (50 minutes in the present embodiment) in an environment that facilitates fermentation.

Depending on the case, a process such as deflating or rounding the dough may be performed during the fermentation step. When the time for the fermentation step is fixed, the circumstances in which the bread dough rises may vary due to outside air temperature. It is therefore possible to use a configuration in which the outside air temperature is detected at the start of the fermentation step, and the time required for the fermentation step is modified depending on the outside air temperature. It is preferred that the fermentation step be shortened in the case that the outside air temperature is high, and that the fermentation step be lengthened in the case that the outside air temperature is low.

When the fermentation step is ended, a baking step is subsequently carried out according to an instruction from the control apparatus 81. The control apparatus 81 controls the sheath heater 41 to increase the temperature of the baking compartment 40 to a temperature suitable to baking bread (e.g., 125° C.) and bake the bread for a prescribed time (i.e., 50 minutes according to the present embodiment) in this baking environment. The user is notified of the end of the baking step, e.g., by a display on a liquid crystal display panel, an audio alert, or the like (neither is shown) on the operation part 20. When the baking of the bread is determined to be complete, the user opens the lid 30 takes out the bread container 50.

As described above, the automatic bread maker 1 of the present embodiment makes it possible to bake bread from rice grains, providing great convenience. Highly refined, delicious bread can be baked without a cooling apparatus being provided because a configuration is used in which a post-grinding water-absorption step is provided between the grinding step for grinding the rice grains and the kneading step for kneading bread dough.

The automatic bread maker illustrated above is one example of the present invention, but the configuration of an automatic bread maker utilizing the present invention is not limited by the embodiments illustrated above.

The embodiments described above are configured so that bread is made from rice grains, but the present invention is not limited to rice grains and can be applied to cases in which bread is made from wheat, barley, millet, Japanese millet, buckwheat, corn, soy bean, and other cereal grains as ingredients.

In the embodiment described above, the portion configured so as to detect the temperature of the bread container 50 may be modified to detect the temperature of the bread ingredients put into the bread container 50. The portion configured to detect the outside air temperature may, depending on the case, be modified so as to detect the surrounding temperature of the bread container 50 (the temperature inside the baking compartment 40).

Further, in the embodiment described above, the time required for the post-grinding water absorption step (i.e., ending time period of the post-grinding water absorption step) is determined while the temperature of the bread container 50 is appropriately detected during the post-grinding water absorption step. Alternatively, it is also possible to adopt a configuration in which, for example, the temperature of the bread container 50 and the outside air temperature are detected when the post-grinding water absorption step is started, and the time required for the post-grinding water absorption step is determined from the temperature of the bread container 50 and a rate of temperature decrease of the bread container 50 predicted according to the outside air temperature (the rate of temperature decrease must be determined in advance on the basis of experimentation).

The bread-making steps performed in the above-described bread-making procedure for rice grains are given by way of example, and other steps may be employed. For instance, the embodiment indicated above may be configured so that the pre-grinding water absorption step is performed prior to the grinding step when bread is made from rice grains, but in one configuration that may also be adopted, the pre-grinding water absorption step is not performed.

Additionally, the embodiments described above are configured such that the automatic bread maker 1 comprises two blades, i.e., the grinding blade 54 and the kneading blade 72. However, no limitation is imposed thereby, it also being possible to use a configuration in which the automatic bread maker comprises only a single blade that doubles for grinding and kneading.

### INDUSTRIAL APPLICABILITY

The present invention is suitably used in an automatic bread maker for household use.

### LIST OF REFERENCE SIGNS

1 automatic bread maker
10 body
18 first temperature detector
19 second temperature detector
50 bread container
81 control apparatus (control unit)

1. An automatic bread maker, comprising:
a container into which bread ingredients are put;
a body for receiving the container;
a control unit for executing bread-making steps in a state in which the container has been received in the body, wherein
the bread-making steps include a grinding step for grinding cereal grains inside the container, and a post-grinding liquid-absorption step for causing ground flour from cereal grains ground in the grinding step to absorb liquid.

2. The automatic bread maker of claim 1, further comprising
a temperature detector capable of detecting at least one among an outside air temperature, a temperature of the container, a temperature of the surroundings of the container, and a temperature of bread ingredients inside the container, wherein
the control unit controls the time of the post-grinding liquid-absorption step on the basis of the temperature detected by the temperature detector.

3. The automatic bread maker of claim 2, wherein
the temperature detector is provided so as to be capable of detecting the temperature of the container; and
the control unit ends the post-grinding liquid-absorption step when the temperature of the container has reached a predetermined temperature in the post-grinding liquid-absorption step.

4. The automatic bread maker of claim 3, wherein
the temperature detector is provided so as to be capable of detecting the outside air temperature in addition to the temperature of the container; and
the control unit ends the post-grinding liquid-absorption step when the temperature of the container has reached the outside air temperature in the case that the outside air temperature is higher than a predetermined temperature in the post-grinding liquid-absorption step.

5. The automatic bread maker of claim 3 or 11, wherein
the control unit
controls the post-grinding liquid-absorption step so that the time of the post-grinding liquid-absorption step is a first time or greater and a second time or less;
does not end the post-grinding liquid-absorption step in the case that the first time has not been reached, even in the case of a determination having been made that the post-grinding liquid-absorption step can be ended on the basis of information from the temperature detector; and
ends the post-grinding liquid-absorption step in the case that the second time is exceeded, even in the case of a determination having been made that the post-grinding liquid-absorption step cannot be ended on the basis of information from the temperature detector.

6. The automatic bread maker of claim 1, further comprising:
a temperature detector capable of detecting at least any one among an outside air temperature, a temperature of the container, a temperature of the surroundings of the container, and a temperature of the bread ingredients inside the container, wherein
the control unit determines an absorption time in the post-grinding liquid-absorption step on the basis of a liquid-absorption time table in which the liquid-absorption time is established in correlation with the temperature, and the temperature detected using the temperature detector prior to the grinding of the cereal grains or after the grinding of the cereal grains.

7. The automatic bread maker of claim 1, wherein sequentially performed in the bread-making steps are: a pre-grinding liquid-absorption step for causing liquid to be absorbed by the cereal grains in the container; the grinding step; the post-grinding liquid-absorption step; a kneading step for kneading into bread dough the bread ingredients within the bread container including ground flour from the cereal grains; a fermentation step for fermenting the kneaded bread dough; and a baking step for baking the fermented bread dough.

8. The automatic bread maker of claim 4, wherein
the control unit
controls the post-grinding liquid-absorption step so that the time of the post-grinding liquid-absorption step is a first time or greater and a second time or less;
does not end the post-grinding liquid-absorption step in the case that the first time has not been reached, even in the case of a determination having been made that the post-grinding liquid-absorption step can be ended on the basis of information from the temperature detector; and
ends the post-grinding liquid-absorption step in the case that the second time is exceeded, even in the case of a determination having been made that the post-grinding liquid-absorption step cannot be ended on the basis of information from the temperature detector.
